(19) United States
(12) Patent Application Publication
(10) Pub. No.: US 2017/0268736 A1
(43) Pub. Date: Sep. 21, 2017

(54) Extender For Surface Mount Light Fixtures

(71) Applicants: Kevin Roy Harpenau, Peachtree City, GA (US); Russell Bryant Green, Douglasville, GA (US); William Randolph Johnson, JR., Peachtree City, GA (US)

(72) Inventors: Kevin Roy Harpenau, Peachtree City, GA (US); Russell Bryant Green, Douglasville, GA (US); William Randolph Johnson, JR., Peachtree City, GA (US)

(21) Appl. No.: 14/630,428

(22) Filed: Feb. 24, 2015

(51) Int. Cl. F21S 8/04; F21V 23/02; F21V 21/04; F21S 8/00

(52) U.S. Cl. CPC F21S 8/043; F21S 8/036; F21V 23/023; F21V 21/04

(57) ABSTRACT

A light fixture mounting assembly comprises an extender and a bracket. The extender comprises a junction box end configured to couple to a junction box, a fixture end located a distance from the junction box end, a perimeter wall extending from the junction box end to the fixture end, and a first set of screw holes formed within the junction box end or the fixture end. The bracket comprises a raised portion and one or more flange portions coupled to the raised portion. The one or more flange portions have a second set of screw holes formed therein. The one or more flange portions are disposed against the fixture end of the extender. The raised portion is disposed through an opening formed in the extender, and the second set of screw holes of the bracket is aligned with the first set of screw holes.

### TECHNICAL FIELD

Embodiments of this disclosure relate generally to mounting light fixtures to junction boxes, and more particularly to an extender which provides additional clearance between a light fixture and a junction box.

### BACKGROUND

Recent developments in the lighting industry has seen a trend towards the use of LED technology, due to their increased efficiency and long-term cost effectiveness over traditional lighting such as fluorescent tubes and incandescents. However, LED lights generally require different supporting electronics, such as an LED driver. Thus, light fixtures that utilize LED lights generally also include an electronics component. In many ceiling or wall mount LED type light fixtures, the light fixture includes a protruding electronics compartment which houses the electronics that drive the LED lights.

Mounted light fixtures, such as wall or ceiling mount light fixtures, often require the light fixture to be coupled to a junction box in order power the light fixture. Many existing junction boxes were not originally designed for LED type light fixtures which include a protruding electronics compartment. Thus, in such cases, there may not be enough clearance within the junction box to allow the light fixture to fit against the junction box or ceiling. This may leave an unsightly gap between the junction box, wall, or ceiling, and the light fixture.

### SUMMARY

In an example embodiment of the present disclosure, an extender for mounting a light fixture comprises a ceiling end comprising a circular ledge and a gasket disposed on the circular ledge, the ceiling end configured to seal the extender against a ceiling. The extender also includes a circular wall extending a distance from the circular ledge. The extender further includes a fixture end coupled to the circular wall opposite the ceiling end, the fixture end comprising a circular plate having an outer perimeter and an opening formed therein. The fixture end also comprises one or more screw holes formed therein configured to receive one or more screws. The one or more screws couple the extender to a junction box within the ceiling, and the circular wall extends from the ceiling end to the outer perimeter of the circular plate.

In another example embodiment of the present disclosure, an extender for mounting a light fixture comprises a junction box end having a first set of screw holes and a central opening formed therein, a circular wall extending a distance from the junction box end, and a fixture end coupled to the circular wall opposite the junction box end. The fixture end comprises an inner perimeter and an outer perimeter. The circular wall extends from the junction box end to the inner perimeter of the fixture end. The fixture end further comprises a lip extending down from the outer perimeter.

In another example embodiment of the present disclosure, a light fixture mounting assembly includes an extender. The extender includes a junction box end configured to couple to a junction box, the junction box end having a first perimeter and a first orifice. The extender also includes a fixture end located a distance from the junction box end, the fixture end having a second perimeter and a second orifice. The extender further includes a perimeter wall extending from the junction box end to the fixture end and a first set of screw holes formed within the junction box end or the fixture end. The light fixture mounting assembly also includes a mounting feature. The mounting feature configured to couple the extender to a mounting bracket or a light fixture.

### BRIEF DESCRIPTION OF THE DRAWINGS

Reference will now be made to the accompanying drawings, which are not necessarily drawn to scale, and wherein:

FIG. 1 illustrates a perspective view of a ceiling mount light assembly, in accordance with example embodiments of the present disclosure.

FIG. 2 illustrates a cross-sectional view of the ceiling mount light assembly of FIG. 1 mounted to a ceiling, in accordance with example embodiments.

FIG. 3 illustrates a perspective view of an extender, in accordance with example embodiments of the present disclosure.

FIG. 4 illustrates a perspective view of the extender of FIG. 3 with a bracket attached, in accordance with example embodiments of the present disclosure.

FIG. 5 illustrates a top perspective view of the light fixture of FIGS. 1 and 2, in accordance with example embodiments of the present disclosure.

FIG. 6 illustrates another example embodiment of a bracket used with the extender, in accordance with example embodiments of the present disclosure.

FIG. 7 illustrates a perspective view of a ceiling mount light assembly with a wet location junction box, in accordance with example embodiments of the present disclosure.

FIG. 8 illustrates a side view of the ceiling mount light assembly of FIG. 7 mounted to a ceiling, in accordance with example embodiments of the present disclosure.

FIG. 9 illustrates a cross-sectional view of the ceiling mount light assembly of FIG. 7, in accordance with example embodiments of the present disclosure.

FIG. 10 illustrates a perspective view of another embodiment of an extender, in accordance with example embodiments of the present disclosure.

FIG. 11 illustrates a perspective view of the extender of FIG. 10 and a bracket coupled to a wet location junction box, in accordance with example embodiments of the present disclosure.

FIG. 12 illustrates an extender coupling a light fixture to a rectangular junction box, in accordance with example embodiments of the present disclosure.

FIG. 13 illustrates a perspective view of an adapter attached to a junction box, in accordance with example embodiments of the present disclosure.

### DETAILED DESCRIPTION OF EXAMPLE EMBODIMENTS

The example embodiments discussed herein are directed to an extender for a surface mounted light module. The example embodiments are better understood by reading the following description of non-limiting, example embodiments with reference to the attached drawings, wherein like parts of each of the figures are identified by like reference characters, and which are briefly described as follows. In the following detailed description of the example embodiments, numerous specific details are set forth in order to provide a more thorough understanding of the disclosure herein. However, it will be apparent to one of ordinary skill in the art that the example embodiments disclosed herein may be practiced without these specific details. In other instances, well-known features have not been described in detail to avoid unnecessarily complicating the description.

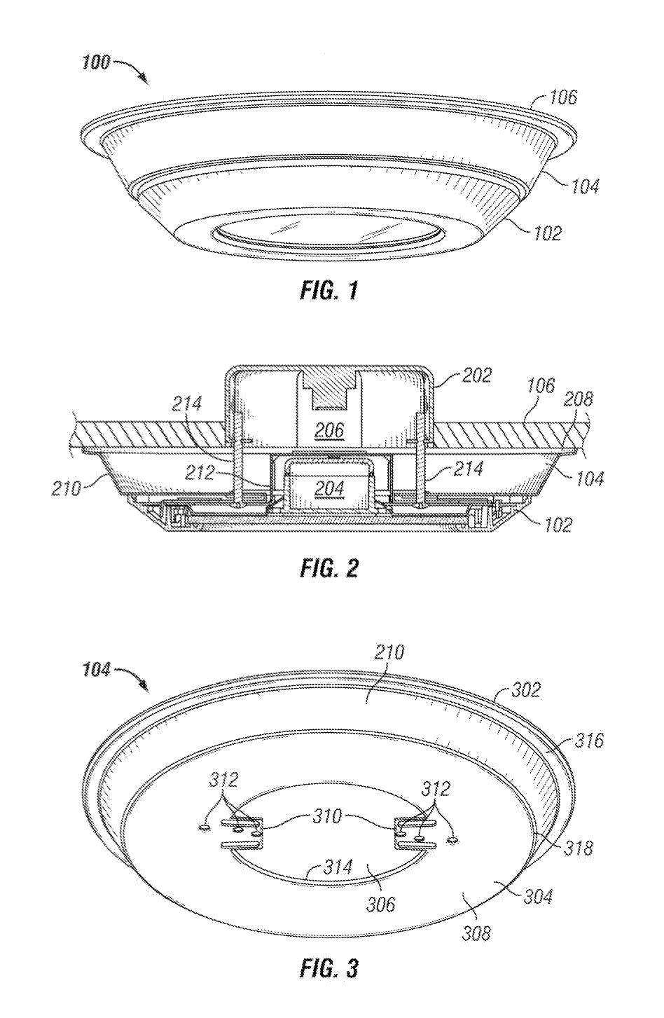

Turning to the figures, FIG. 1 illustrates a perspective view of a ceiling mount light assembly 100, in accordance with example embodiments of the present disclosure. FIG. 2 illustrates a cross-sectional view of the ceiling mount light assembly mounted to a ceiling 106, in accordance with example embodiments. Referring to FIGS. 1 and 2, the ceiling mount light assembly 100 includes a ceiling mount light fixture 102 and an extender 104. In certain example embodiments, the light fixture 102 is an LED-based light fixture and includes an electronics component. The ceiling 106 includes a junction box 202. In certain example embodiments, the junction box 202 includes a mounting block 206 disposed therein. In certain example embodiments, the extender 104 is mounted to the ceiling 106 and the light fixture 102 is mounted to the extender 104 opposite the ceiling 106. The extender 104 creates a clearance between the light fixture 102 and the mounting block 206 in the junction box 202. The clearance allows an electronics compartment 204 of the light fixture 102 to be disposed within a space in the extender 104, and allows the light fixture 102 to be disposed flush against the extender 104. In certain example embodiments, the light fixture 102 is mounted to the extender 104 via a bracket 212. In certain example embodiments, the extender 104 and bracket 212 are coupled to the junction box 202 via one or more screws 214.

FIG. 3 illustrates a perspective view of the extender 104 of FIGS. 1 and 2, in accordance with example embodiments of the present disclosure. Referring to FIGS. 2 and 3, in certain example embodiments, the extender 104 includes a ceiling end 302 which is mounted against the ceiling 106 and a fixture end 304 to which the light fixture 102 is mounted. In certain example embodiments, the ceiling end 302 includes a gasket 208 which forms a seal between the ceiling 106 and the extender 104. In certain example embodiments, a gasket may not be used. In certain example embodiments, the ceiling end 302 includes a ledge 316 on which the gasket 208 is disposed. The fixture end 304 includes a circular plate 308 having an opening 306 formed therein. In certain example embodiments, the circular plate 308 includes one or more tabs 310 extending into the opening 306. In certain example embodiments, the tabs 310 include one or more screw holes 312 formed therein. In certain example embodiments, an edge 314 of the circular plate 308 adjacent the opening 306 is rolled, which provides a more structurally robust edge 314. In certain example embodiments, the ceiling end 302 and the fixture end 304 is coupled via a side wall 210 which extends from the ledge 316 to an outer perimeter 318 of the circular plate 308. In certain example embodiments, the circular plate 308 is concentric with the ledge 316 and the circumference of the outer perimeter 318 is smaller than the circumference of the ledge 316 such that side wall 210 has an sloping configuration. In certain example embodiments, the light fixture 102 also has a sloping configuration at the sides. Thus, the profile of the extender 106 generally matches that of the light fixture 102, giving the assembly 100 a generally continuous appearance. In other example embodiments, the extender 106 can have various other profile configurations and shapes.

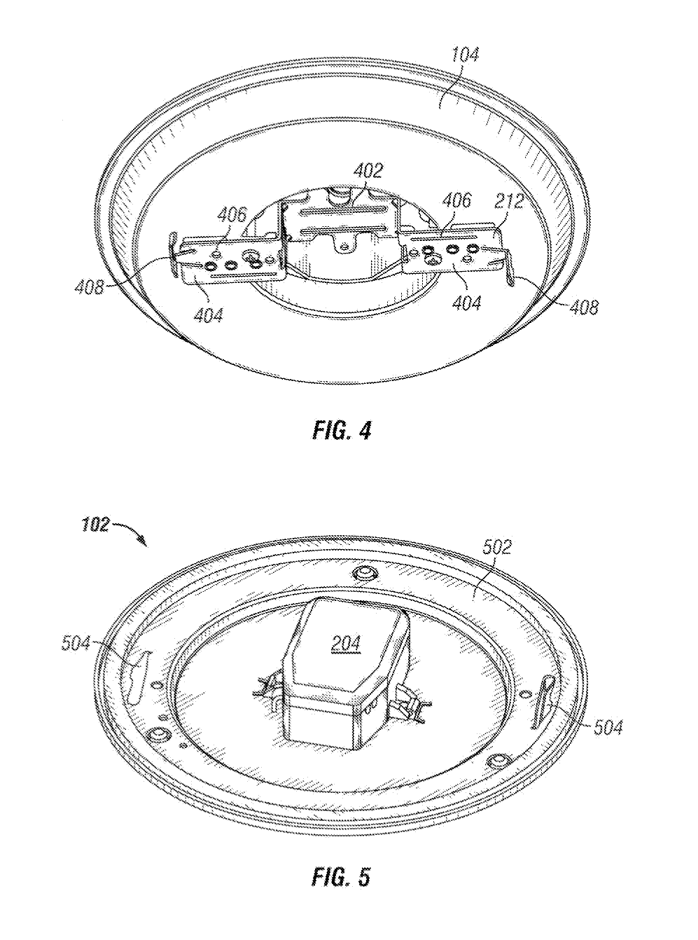

FIG. 4 illustrates a perspective view of the extender 104 with the bracket 212 attached, in accordance with example embodiments of the present disclosure. In certain example embodiments, the bracket 212 includes a raised portion 402 and two flank portions 404 coupled to opposite sides of the raised portion 402. The raised portion 402 is inserted through the opening 306 in the extender 106 and is positioned within the clearance provided by the extender 104. The flank portions 404 are coupled against the circular plate 308 of the extender 104. The flank portions 404 include one or more screw holes 406 through which the screws 214 couple the bracket 212 to the extender 104 and the junction box 202. The bracket 212 further includes a hook tab 408 extending from each of the flange portions 404. The hook tabs 408 are configured to engage with the light fixture 102 and suspend the light fixture 102 therefrom.

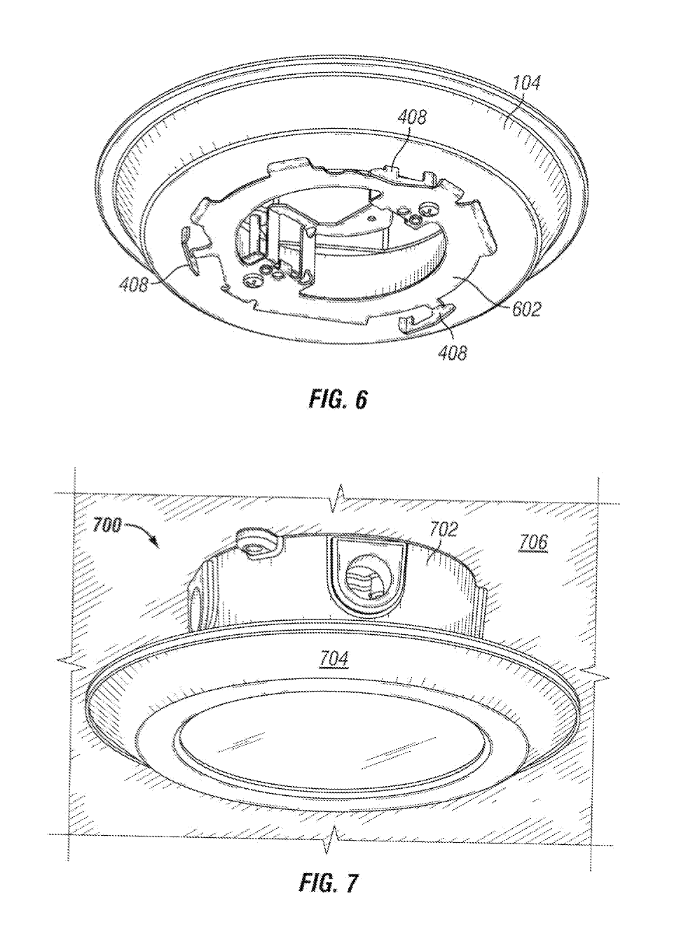

FIG. 5 illustrates a top perspective view of the light fixture 102 of FIGS. 1 and 2, in accordance with example embodiments of the present disclosure. In certain example embodiments, the light fixture 102 includes a top housing 502. In certain example embodiments, the top housing 502 includes the electronics compartment 204. In certain example embodiments, the top housing 502 includes one or more slots 504 formed therein. The one or more slots 504 are configured to receive the hook tabs 408 of the bracket 212. In certain example embodiments, the light fixture 102 is coupled to the bracket 212 by inserting the hook tabs 408 of the bracket 212 into the respective slots 504 and slightly twisting the light fixture 102 relative to the bracket 212 until a hooked portion of the hook tab 408 is beneath and supporting the top housing 502, thereby suspending the light fixture 102. The electronics compartment 204 is disposed beneath the raised portion 402 of the bracket 212 within the extender 104. FIG. 6 illustrates another example embodiment of a bracket 602 used with the extender 106, in accordance with example embodiments of the present disclosure. In certain example embodiments, the bracket 602 of FIG. 6 has a generally round shape rather than the linear shape of the bracket 212 of FIG. 4. The bracket 602 also includes one or more hook tabs 408 and one or more screw holes by which the bracket 602 is secured to the extender 104 and the junction box 202. The bracket 602 is configured to be used with a different light fixture than the light fixture used with the bracket 212. In certain example embodiments, the bracket 212, 602 can take on any configuration compatible with the light fixture with which it is used. In certain example embodiments, the light assembly 100 includes one or more other mounting features by which a light fixture 102 can be coupled to the extender. A bracket is one example of such a means of coupling the light fixture 102 to the extender. In certain example embodiments, the light fixture 102 can be coupled to the extender without the bracket.

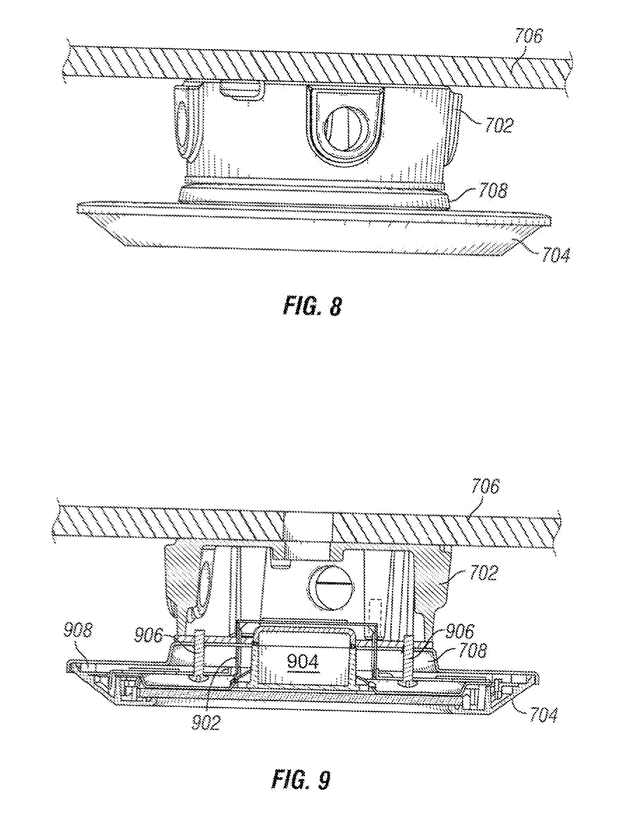

FIG. 7 illustrates a perspective view of a ceiling mount light assembly 700 having a wet location junction box 702, in accordance with example embodiments of the present disclosure. FIG. 8 illustrates a side view of the ceiling mount light assembly 700 mounted to a ceiling 706, in accordance with example embodiments. FIG. 9 illustrates a cross-sectional view of the ceiling mount light assembly 700. Referring to FIGS. 7, 8, and 9, the ceiling mount light assembly 700 further includes a light fixture 704 and an extender 708. The extender 708 couples the light fixture 704 to the junction box 702. In certain example embodiments, the junction box 702 is at least partially disposed on and external to the ceiling 706.

The extender 708 is mounted to the junction box 702 and the light fixture 704 is mounted to the extender 708 opposite the junction box 702. The extender 708 adds a clearance between the light fixture 702 and junction box 702, which creates room in which an electronics compartment 904 is disposed. In certain example embodiments, the light fixture 702 is mounted to the extender 708 via a bracket 902. In certain example embodiments, the extender 708 and bracket 902 are coupled to the junction box 702 via one or more screws 906.

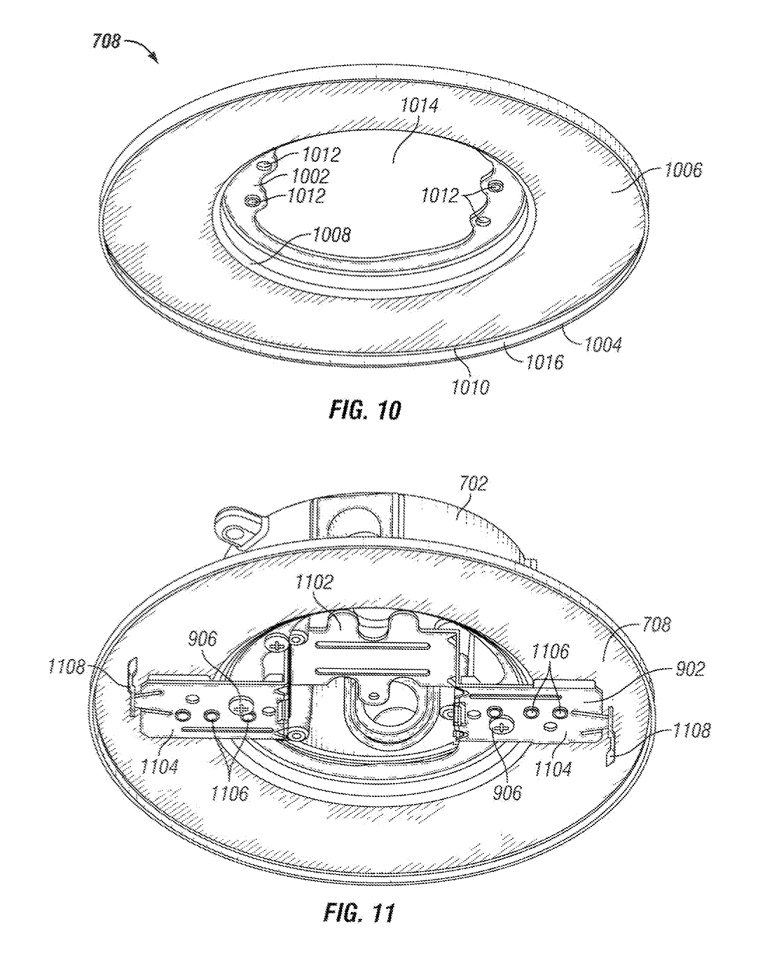

FIG. 10 illustrates a perspective view of the extender 708 of FIGS. 8 and 9, in accordance with example embodiments of the present disclosure. Referring to FIGS. 8 and 9, in certain example embodiments, the extender 708 includes a junction box end 1002 which is mounted against the junction box 702 and a fixture end 1004 to which the light fixture 704 is mounted. In certain example embodiments, the extender 708 includes a circular disk 1006 having an inner perimeter 1008 and an outer perimeter 1010. In certain example embodiments, the junction box end 1002 is a raised portion of the extender 708 extending a certain distance from the inner perimeter 1008, providing additional clearance. The junction box end 1002 includes one or more screw holes 1012 and an opening 1014. In certain example embodiments, the fixture end 1004 is coupled to the outer perimeter 1010 and includes a lip 1016. The lip 1016 covers an edge of the light fixture 704 when the light fixture 704 is installed.

FIG. 11 illustrates a perspective view of the extender 708 with the bracket 902 attached, in accordance with example embodiments of the present disclosure. In certain example embodiments, the bracket 902 includes a raised portion 1102 and two flank portions 1104 coupled to opposite sides of the raised portion 1102. The raised portion 1102 is inserted through the opening 1014 in the extender 708 and is positioned within the clearance provided by the extender 708 and a portion of the junction box 702. The flank portions 1104 are coupled against the circular disk 1006 of the extender 708. The flank portions 1104 include one or more screw holes 1106 through which one or more screws 906 couple the bracket 902 to the extender 708 and the junction box 702, as illustrated in FIGS. 9 and 11. The bracket 902 further includes a hook tab 1108 extending from each of the flange portions 1104. The hook tabs 1108 are configured to be inserted into and engaged with corresponding slots of the light fixture 704 and suspend the light fixture 704 therefrom. Referring to FIG. 9, in certain example embodiments, a gasket 908 is disposed between the light fixture 704 and the extender 708.

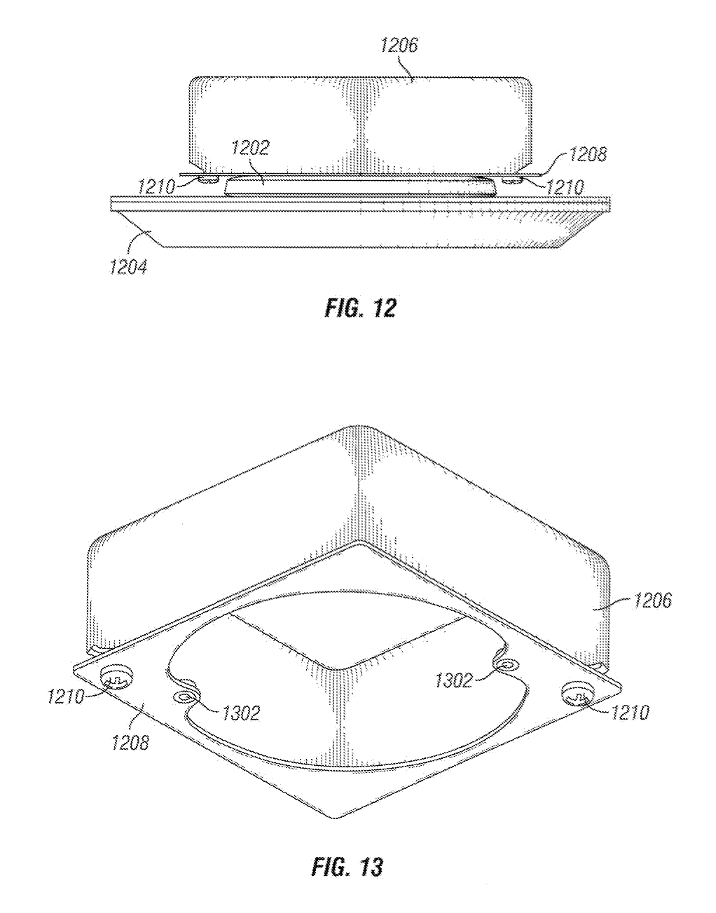

Embodiments of the extender of the present disclosure can be used to couple light fixtures to various types of junction boxes. FIG. 12 illustrates an extender 1202 coupling a light fixture 1204 to a rectangular junction box 1206, in accordance with example embodiments of the present disclosure. In certain example embodiments, the extender 1202 is coupled to the junction box 1206 via an adapter 1208. FIG. 13 illustrates a perspective view of the adapter 1208 attached to the junction box 1206. Specifically, the adapter 1208 is coupled to the junction box 1206 via one or more screws 1210 traversing a first set of screw holes in the adapter 1208. The adapter 1208 supplies a second set of screw holes 1302 by which the extender 1202 can be coupled to the adapter 1208. In such example embodiments, the extender 1202 and a bracket (not shown) are coupled to the adapter 1208 in a similar manner as how the extender 708 and bracket 902 of FIG. 9 is coupled to the junction box 702.

Example embodiments of the extender can be fabricated from metal or strong plastic materials, and can have various dimensions for accommodating junctions boxes and light fixtures are various configurations. In certain example embodiments, the extender has an outer profile which matches or aligns with the profile of the light fixture. The extender can vary in height, providing various amounts of clearance for the electronics compartment of the light fixture.

Although embodiments described herein are made with reference to example embodiments, it should be appreciated by those skilled in the art that various modifications are well within the scope and spirit of this disclosure. Those skilled in the art will appreciate that the example embodiments described herein are not limited to any specifically discussed application and that the embodiments described herein are illustrative and not restrictive. From the description of the example embodiments, equivalents of the elements shown therein will suggest themselves to those skilled in the art, and ways of constructing other embodiments using the present disclosure will suggest themselves to practitioners of the art. Therefore, the scope of the example embodiments is not limited herein.

What is claimed is:

1. An extender for mounting a light fixture, comprising:
a mounting end comprising a circular ledge and a gasket disposed on the circular ledge, the mounting end configured to seal the extender against a surface;
a circular wall extending a distance from the circular ledge; and
a fixture end coupled to the circular wall opposite the mounting end, the fixture end comprising a circular plate having an outer perimeter and an opening formed therein, wherein the fixture end also comprises one or more screw holes formed therein configured to receive one or more screws, and wherein the circular wall extends from the mounting end to the outer perimeter of the circular plate.

2. The extender of claim 1, further comprising one or more tabs extending from the circular plate into the opening, the one or more tabs comprising the one or more screw holes.

3. The extender of claim 1, wherein the outer perimeter of the circular plate is smaller than a diameter of the circular ledge, and the circular wall has a sloping profile as it extends from the mounting end to the fixture end.

4. The extender of claim 1, further comprising:
a bracket comprising:
a raised portion; and
one or more flange portions coupled to the raised portion, wherein the one or more flange portions have a second set of screw holes formed therein,
wherein the one or more flange portions are disposed against the fixture end of the extender, wherein the raised portion is disposed through the opening, and wherein the second set of screw holes of the bracket is aligned with the one or more screw holes of the circular plate, and wherein the bracket is coupled to the extender via the one or more screws

5. The extender of claim 5, wherein the bracket further comprises one or more hook tabs disposed on the one or more flange portions, the hook tabs configured to engage with and support a light fixture.

6. The extender of claim 5, wherein the circular wall has a profile that matches the profile of the light fixture.

7. An extender for mounting a light fixture, comprising:
a junction box end having a first set of screw holes and a central opening formed therein;
a circular wall extending a distance from the junction box end; and
a fixture end coupled to the circular wall opposite the junction box end, the fixture end comprising an inner perimeter and an outer perimeter, wherein the circular wall extends from the junction box end to the inner perimeter of the fixture end, and wherein the fixture end further comprises a lip extending down from the outer perimeter.

8. The extender of claim 7, further comprising:
a bracket comprising:
a raised portion; and
one or more flange portions coupled to the raised portion, wherein the one or more flange portions have a second set of screw holes formed therein,
wherein the one or more flange portions are disposed against the fixture end of the extender, wherein the raised portion is disposed through the central opening, and wherein the second set of screw holes of the bracket is aligned with the first set of screw holes of the extender,

9. The extender of claim 8, wherein the bracket further comprises one or more hook tabs disposed on the one or more flange portions, the hook tabs configured to engage with and support a light fixture.

10. The extender of claim 8, wherein the distance between the junction box end and the fixture end provides additional clearance for an electronics compartment of the light fixture.

11. The extender of claim 8, wherein the bracket is coupled to the extender and a junction box via one or more screws traversing the first set of screw holes and the second set of screw holes.

12. The extender of claim 7, wherein the extender couples a light fixture to a wet location junction box.

13. The extender of claim 7, wherein the extender comprising an adapter plate, wherein the adapter plate comprises a first set of adapter screw holes and a second set of adapter screw holes, and wherein the adapter is coupled to a junction box via the first set of adapter screw holes and the extender is coupled to the adapter via the second set of adapter screw holes.

14. A light fixture mounting assembly, comprising:
an extender comprising:
a junction box end configured to couple to a junction box, the junction box end having a first perimeter and a first orifice;
a fixture end located a distance from the junction box end, the fixture end having a second perimeter and a second orifice;
a perimeter wall extending from the junction box end to the fixture end; and
a first set of screw holes formed within the junction box end or the fixture end; and
a mounting feature configured to couple the extender to a mounting bracket or a light fixture.

15. The light fixture mounting assembly of claim 14, wherein the mounting bracket further comprises one or more hook tabs disposed on the one or more flange portions, the hook tabs configured to engage with and support a light fixture.

16. The light fixture mounting assembly of claim 15, wherein the distance between the junction box end and the fixture end provides additional clearance for an electronics compartment of the light fixture.

17. The light fixture mounting assembly of claim 14, wherein the extender has a circular or polygonal shape.

18. The light fixture mounting assembly of claim 14, wherein the junction box end comprises a ledge and a gasket disposed in the ledge, the gasket configured to seal the extender against a surface

19. The light fixture mounting assembly of claim 16, wherein the profile of the extender matches the profile of the light fixture.

20. The light fixture mounting assembly of claim 14, wherein the extender and mounting bracket are coupled to a junction box via one or more screws traversing the first set of screw holes and the second set of screw holes.
